(19) United States
(12) Patent Application Publication
(10) Pub. No.: US 2007/0044013 A1
(43) Pub. Date: Feb. 22, 2007

(54) Methods, devices and computer program products for saving content of a mobile terminal display

(75) Inventor: Edward Craig Hyatt, Durham, NC (US)

Correspondence Address: MYERS BIGEL SIBLEY & SAJOVEC, PO BOX 37428, RALEIGH, NC, 27627, US

(73) Assignee: Sony Ericsson Mobile Communications AB

(21) Appl. No.: 11/206,436

(22) Filed: Aug. 18, 2005

(51) Int. Cl. G06F 17/24; G06F 17/21

(52) U.S. Cl. 715/515; 715/530

(57) ABSTRACT

Methods, devices and computer program products are provided for saving content of a mobile terminal display. A request is received to store the content of a display associated with the mobile terminal. An image file is generated including the content of the of the display responsive to the received request. The generated image file is stored in a screen content folder regardless of a type of the content and/or a source of the content.

### FIELD OF THE INVENTION

The present invention relates to mobile terminals and, more particularly, to mobile terminals capable of accessing, sending and receiving data and related methods and computer program products.

### BACKGROUND OF THE INVENTION

Recently, there has been a proliferation of features in the field of mobile communications. Mobile terminals, such as cordless and cellular telephones, pagers, wireless modems, wireless email devices, personal digital assistants (PDAs) with communication functions, MP3 players and other portable communications devices are becoming more commonplace. Some of these devices are configured to communicate with a data network, such as the Internet, over the wireless communications network, some are configured to take pictures or send and receive email, Short Message Service (SMS) and Multimedia Messaging Service (MMS) messages. Thus, mobile terminals are capable of storing an abundance of information, for example, pictures, contacts, messages received and sent and the like.

Each of the different applications, i.e., SMS, MMS, pictures, contacts and the like, use different procedures for saving media content. The content generated by each of the applications is stored in different folders on the mobile terminal based on the type of and/or source of the application. Furthermore, some of the content capable of being access by the mobile terminal cannot be saved in the mobile terminal at all.

### SUMMARY OF THE INVENTION

Some embodiments of the present invention provide methods, devices and computer program products for saving content of a mobile terminal display. A request is received to store the content of a display associated with the mobile terminal. An image file is generated including the content of the display responsive to the received request. The generated image file is stored in a screen content folder regardless of a type of the content and/or a source of the content.

In further embodiments of the present invention, a text file associated with the generated image file may be automatically generated. The text file may include any text included in the image file. The generated text file may be stored in the screen content folder.

In still further embodiments of the present invention, the text file may be attached to an email message, a Multimedia Messaging Service (MMS) message, a Short Message Service (SMS) message. The text file may be forwarded to a text notes program. The image file may be attached to an email message and/or an MMS message.

In some embodiments of the present invention, the image file and/or the text file may be processed to extract information therefrom. The extracted information may be provided to an application program for use therein. The application program may include a contacts database, a calendar, a browser, a chat client and/or a bookmark storage unit.

In further embodiments of the present invention, the image file and/or the text file may be edited. In certain embodiments of the present invention, the user input may be provided through a dedicated screen content button provided on the mobile terminal, the user input may be provided through an overloaded button provided on the mobile terminal or the user input may be provided through a menu provided on the mobile terminal.

### BRIEF DESCRIPTION OF THE DRAWINGS

FIG. 1 is a schematic diagram of a portable electronic device according to some embodiments of the present invention and an exemplary base station transceiver.

FIG. 2 is a schematic illustration of exemplary data flows according to some embodiments of the present invention.

FIGS. 3A through 3E are screen shots illustrating operations of receiving and storing content according to some embodiments of the present invention.

FIGS. 4A through 4D are screen shots and image/text files illustrating operations according to further embodiments of the present invention.

FIGS. 5 through 7 are flowcharts illustrating operations of mobile terminals according to various embodiments of the present invention.

### DETAILED DESCRIPTION OF EMBODIMENTS OF THE INVENTION

Specific exemplary embodiments of the invention now will be described with reference to the accompanying drawings. This invention may, however, be embodied in many different forms and should not be construed as limited to the embodiments set forth herein; rather, these embodiments are provided so that this disclosure will be thorough and complete, and will fully convey the scope of the invention to those skilled in the art. The terminology used in the detailed description of the particular exemplary embodiments illustrated in the accompanying drawings is not intended to be limiting of the invention. In the drawings, like numbers refer to like elements.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, a “mobile terminal” includes both devices having only a wireless signal receiver without transmit abilities and devices having both receive and transmit hardware capable of two-way communication over a two-way communication link. Such devices may include cellular or other communications devices with or without a multi-line display; Personal Communications System (PCS) terminals that may combine a voice and data processing, facsimile and/or data communications capabilities; Personal Digital Assistants (PDA) that can include a radio frequency receiver and a pager, Internet/Intranet access, Web browser, organizer, calendar and/or a global positioning system (GPS) receiver; and/or conventional laptop and/or palmtop computers or other appliances, which include a radio frequency receiver. As used herein, “mobile terminals” may be portable, transportable, installed in a vehicle (aeronautical, maritime, or land-based), or situated and/or configured to operate locally and/or in a distributed fashion at any other location(s) on earth and/or in space.

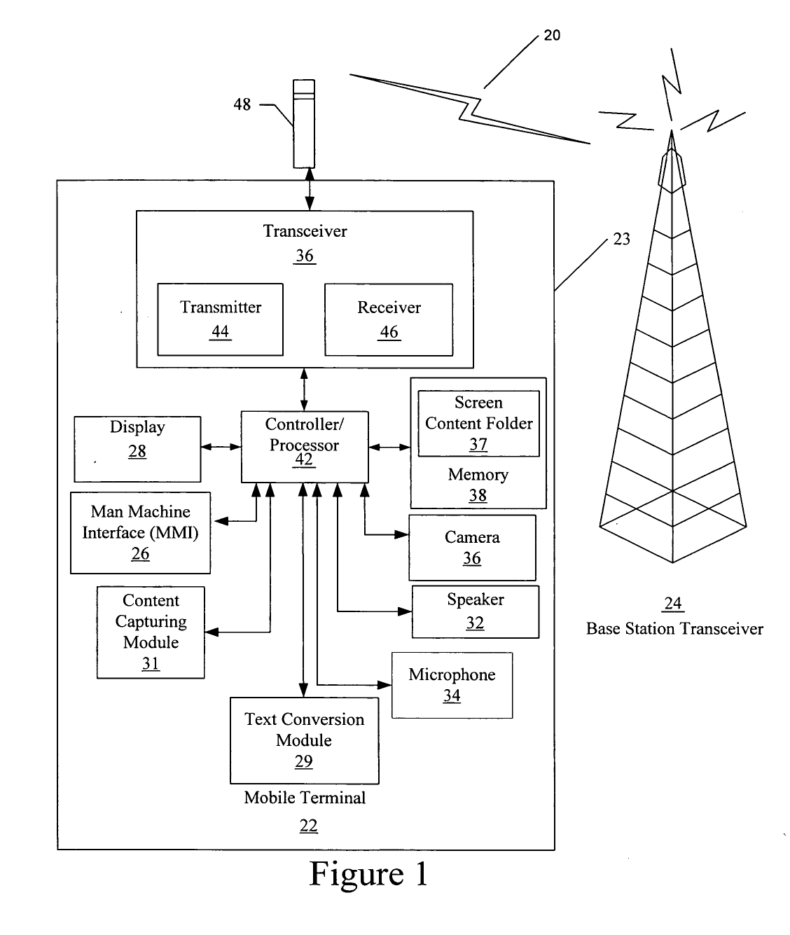

As discussed herein with respect to FIGS. 1 through 7, embodiments of the present invention provide methods, devices and computer program products for saving content of a mobile terminal display. As used herein “content” refers to anything that is capable of being displayed on the mobile terminal. For example, the content of the mobile terminal display could be an SMS message, an MMS message, a web page, a photograph, a contact listing and the like. Some embodiments of the present invention receive a request to store the current content of the mobile terminal display and then store the content in an image file that is stored in a screen content folder regardless of the type of content and/or the source of the content. Thus, all of the saved/stored image files would be saved in the same place (screen content folder) for easy access by the user of the mobile terminal. Furthermore, in some embodiments of the present invention, a text file including the text of the stored content, if any, is automatically generated and stored in the same screen content folder. The stored image and/or text may then be used in other applications by the mobile terminal as will be discussed further below.

Referring first to FIG. 1, a schematic block diagram is provided illustrating a mobile terminal 22 including a content capturing module 31, a text conversion module 29 and a screen content folder 37 in accordance with some embodiments of the present invention. FIG. 1 illustrates a mobile terminal 22 and a base station transceiver 24 of a wireless communications network 20. It will be understood that as wireless technologies evolve, so do “wireless communication networks.” As used herein, a “wireless communication network” may refer to various radio access technologies in the traditional sense, a wireless local area network (LAN) or a wireless personal area network without departing from the teachings of the present invention. These networks may include, for example, radio access technologies, such as Code division multiple access (CDMA), Enhanced Data rates for GSM Evolution (EDGE), General Packet Radio Service (GPRS), Global System for Mobile TeleCommunications (GSM), High-Speed Downlink Packet Access (HSDPA), High-Speed Uplink Packet Access (HSUPA), Universal Mobile Telecommunications System (UMTS), Wideband Code Division Multiple Access (W-CDMA) and/or WCDMA+EDGE (WEDGE) and/or Wireless Local Area Networks (WLAN), such as Wireless Fidelity (WiFi) and Worldwide Interoperability for Microwave Access (WiMAX).

According to some embodiments of the present invention, radio access technologies and/or WLANs may be used as an access media between the mobile terminal 22 and the wireless communication network 20 illustrated in FIG. 1. For example, a mobile terminal 22 may also access a data network via UMTS, GSM, EDGE, GPRS, WEDGE, CDMA, WCDMA, HSDPA, HSUPA, WIFI, WiMAX and the like without departing from the scope of the present invention.

The mobile terminal 22 includes a portable housing 23 and may include, a man machine interface (MMI) 26, for example, a keyboard, camera button and the like, a display 28, a camera 36, a speaker 32, a microphone 34, a transceiver 36, and a memory 38, any of which may communicate with a controller (processor) 42. Furthermore, the mobile terminal 22 includes a content capturing module 31 and a text conversion module 29 according to some embodiments of the present invention, which also communicate with the processor 42. The processor 42 can be any commercially available or custom microprocessor.

It will be understood that although the content capturing module 31 and the text conversion module 29 are illustrated in the mobile terminal as two separate circuits, embodiments of the present invention are not limited to this configuration. For example, the content capturing module 31 and the text conversion module 29 can be combined into a single circuit without departing from the scope of the present invention.

The transceiver 36 typically includes a transmitter circuit 44 and a receiver circuit 46, which respectively transmit outgoing radio frequency signals to the base station transceiver 24 and receive incoming radio frequency signals, such as voice call and data signals, from the base station transceiver 24 via an antenna 48. The antenna 48 may be an embedded antenna, a retractable antenna or any antenna known to those having skill in the art without departing from the scope of the present invention. The radio frequency signals transmitted between the mobile terminal 22 and the base station transceiver 24 may include both traffic and control signals (e.g., paging signals/messages for incoming calls), which are used to establish and maintain a voice call communication with another party or to transmit and/or receive data, such as e-mail or MMS messages, with a remote device. The processor 42 may support various functions of the mobile terminal 22, including functions related to the content capturing module 31 and the text conversion module 29 of the mobile terminal 22 according to some embodiments of the present invention.

In some embodiments of the present invention, the base station transceiver 24 is a radio transceiver(s) that defines a cell in a cellular network and communicates with the mobile terminal 22 and other mobile terminals in the cell using a radio-link protocol. Although only a single base station transceiver 24 is shown, it will be understood that many base station transceivers may be connected through, for example, a mobile switching center and other devices, to define a wireless communications network. The transceiver 36 is configured to communicate with a data network using the wireless communications network 20.

According to some embodiments of the present invention, the content capturing module 31 is configured to receive a request to store the content of the display 28 of the mobile terminal 22. For example, a user may press a button to indicate that they would like to store the current content of the display 28. The button may be a button on the mobile terminal 22 that is dedicated to the content capturing function or may be an overloaded button, i.e., a button already provided on the mobile terminal 22 that is assigned an additional function. The dedicated button and/or the overloaded button may be provided by the MMI 26 of the mobile terminal 22. For example, the button for the content capture function may be the same button used to take a picture on a camera mobile terminal. Thus, whenever the mobile terminal is not in camera mode, and the button is given a short press, then the mobile terminal may be configured to capture the content on the display 28. A long press of the same button may cause the mobile terminal to enter camera mode.

Furthermore, in some embodiments of the present invention, the user may select a content capture option from a menu of options. The menu of options may be accessed using the MMI 26 of FIG. 1. It will be understood that the methods of making a request to capture the current content of a display discussed herein are provided for exemplary purposes only and, therefore, embodiments of the present invention are not limited to these examples. Any method of making a request on a mobile terminal may be used without departing from the scope of the present invention. For example, the request may be made by a touch screen, a touch sensor, a voice command and the like, without departing from the scope of the present invention.

The content may include a picture taken with the mobile terminal, for example, a picture of a magazine page with interesting subject matter, a picture of a colleague's business card or anything of interest to the user, an MMS message, an SMS message, a web page, contact information and the like. Embodiments of the present invention are not limited to these examples. As will be understood by those having skill in the art, the content can be anything capable of being displayed on a mobile terminal display.

Once the request to store the content of the display 28 is received, the content capturing module 31 may be configured to create an image file and store the image file in the screen content folder 37 regardless of the type of the content, for example, MMS, SMS etc., and/or the source of the content. Thus, all the images stored by the content capturing module 31 may be stored in the same folder, for example, the screen content folder 37. Thus, the user will know where this information has been stored without searching through a plurality of files before locating it.

In some embodiments of the present invention, the text conversion module 29 may be configured to automatically create a text file associated with the stored image file that includes the text, if any, in the stored image file. For example, in some embodiments of the present invention, the text conversion module 29 may include optical character recognition software (OCR). The text conversion module 29 may be configured to run in the background, scanning/waiting for the creation/storing of a new image file including the content of the display by the content capturing module 31. When a new image file is stored, the text conversion module 29 may be configured to read the stored content file, extract text from the stored image file, if present, create a corresponding text file and store the text file in the screen content folder 37. Since the process runs in the background, it may not add significant delay to other activities on the mobile terminal. It will be understood that according to some embodiments of the present invention, the extraction of the text from the stored content is “best effort” and may not be perfect. However, the user can edit the text file once it is created to correct any errors that may be present therein. For example, the user may refer to the stored image file to determine what the text should actually say.

It will be understood that although the text conversion module is discussed herein as including functionalities, embodiments of the present invention are not limited to this configuration. For example, if the content of the display includes, for example, a web page, an SMS message, an MMS message or the like, the converted text may be available without the use of an OCR functionality and can be saved in addition to the image file.

According to some embodiments of the present invention, content capturing may be simple to understand and implement. Thus, configuration options of the captured content may be minimal. For example, configuration options may include selecting the save resolution, selecting the screen area to be saved, for example, whether to save the status row and soft keys, allowing the user to delimit the save area with a rectangle, configuring the desired OCR accuracy, detecting embedded URLs, email addresses, phone numbers, whether the user wants to be notified when the capture is done, and the like.

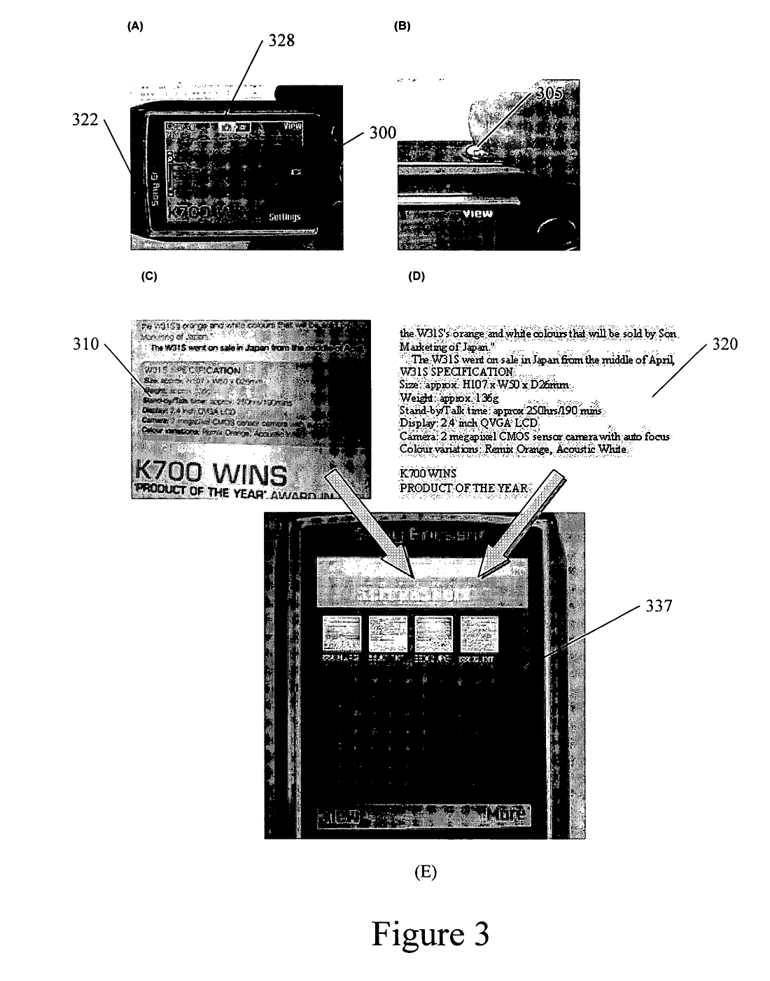

Exemplary operations for capturing screen content and creating text files according to some embodiments of the present invention will now be discussed with respect to FIGS. 1 and 3A through 3E. As illustrated in FIG. 3A, a user may view an image from a magazine article 300 on the display 328 of the mobile terminal 322. The magazine article may include, for example, some mobile terminal specifications and a uniform resource locator (URL). As further illustrated in FIG. 3B, the user may press a dedicated content capture button 305 to request that the image from the magazine article 300 be saved in the screen content folder 337. The content capturing module 31 may receive the request to save the content on the screen, generate an image file 310 (FIG. 3C) and store the image file 310 in the screen content folder 337 as illustrated in FIG. 3E. Furthermore, as discussed above, in some embodiments of the present invention, the text conversion module 29 may be configured to automatically create a text file 320 (FIG. 3D) including the text in the stored image file 310, if any, and store the text file 320 in the screen content folder 337 as further illustrated in FIG. 3E. Thus, as discussed above, both the image file 310 and the text file 320 are saved in the same folder 337 to allow ease of access and use by the user of the mobile terminal 322.

Referring again to FIG. 1, in some embodiments of the present invention, a press of the a dedicated content capture button (a request to save current content) causes the content capturing module 31 to generate an image of the current content and save the image as a JPG file in the dedicated screen content folder 37. JPG is a file format for images that compresses large image files so they don't take up as many kilobytes of memory. Meanwhile, the image file may be automatically queued for the OCR background process by the text conversion module 29. Text may be automatically extracted from the image file. When text, if any, has been extracted by the text conversion module, a text file appears in the screen content folder 37. In some embodiments of the present invention, as files are created, they may be given sequential numeric names as for ordinary photographs. For example digital photos may be assigned names like DSC001, DSC002, and so on for “Digital Sony Camera.” Thus, according to embodiments of the present invention screen shots could be assigned file names like SSI001, SSI002, and so on for “ScreenShot Image” and SST001, SST002, and so on for “ScreenShot Text”. Corresponding graphic and text files may have the same serial number with different prefixes. It will be understood that these file names are provided for exemplary purposes only and, therefore, file names according to embodiments of the present invention are not limited to this configuration.

Although exemplary embodiments of the present invention discuss the image being stored in a JPG format, it will be understood that embodiments of the present invention are not limited to this configuration. For example, the image file may be stored in a bitmap (BMP) format, a graphics interchange format (GIF), a portable network graphics (PNG) format and the like, without departing from the scope of the present invention.

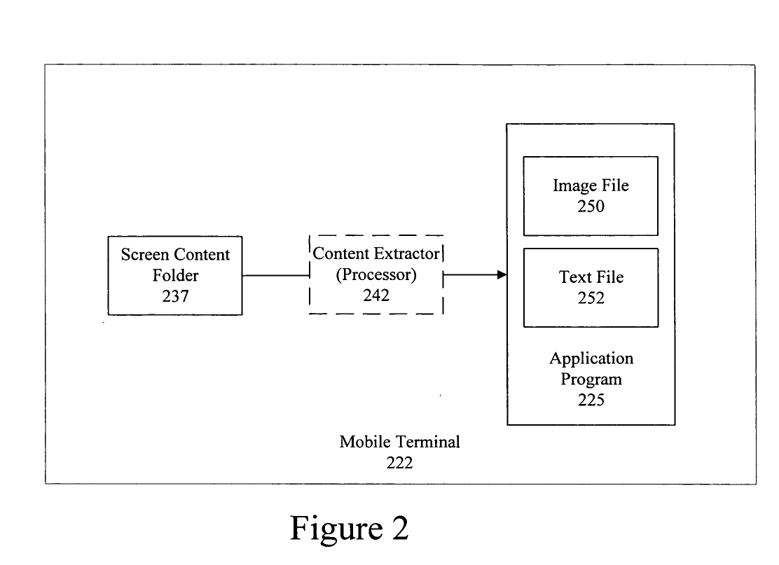

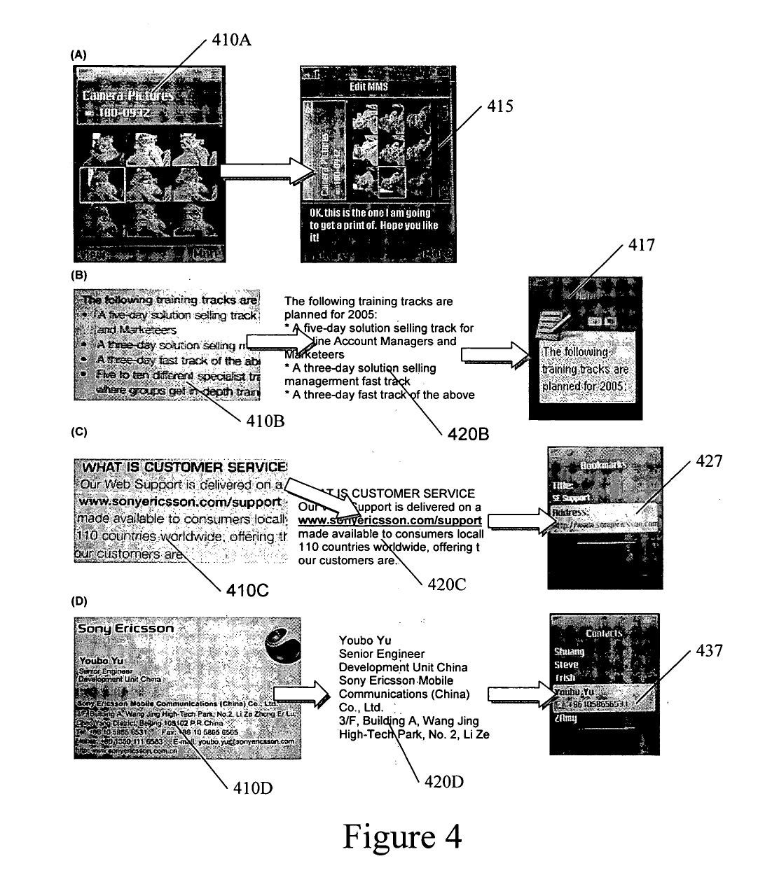

According to some embodiments of the present invention, the image file and the text file, if any, can be attached, processed, edited and the like for use in other applications supported by the mobile terminal. For example, the image and/or text file may be attached to an email or MMS message, saved as a note, added to a calendar, added to a contacts list, saved as a browser bookmark, used to access a website, and the like. Aspects of attaching, processing and editing will be discussed further below with respect to FIGS. 2 and 4A through 4C.

Referring now to FIG. 2, exemplary data flows according to some embodiments of the present invention will be discussed. It will be understood that the data paths provided in FIG. 2 are provided for exemplary purposes only. Thus, more elements may be in the path without departing from the teachings of the present invention. Furthermore, although the content extractor (processor) 242 and the application programs 225 are illustrated as being within the mobile terminal 222, embodiments of the present invention are not limited to this configuration. For example, the application programs 225 may be provided outside the mobile terminal 222 without departing from the scope of the present invention. Dotted lines in FIG. 2 indicate optional flows as discussed further herein.

As discussed above, the contents of the screen content folder 237, for example, images file 250 and/or text files 252, may be provided to application programs 225, for example, email, SMS, and MMS messages, a text notes file, a chat client, a contacts database, a calendar and the like. Some applications may directly accept these files and others may need some processing first before the files are in a useable form. For example, an image file 250 may be directly attached to MMS and email messages. Similarly, a text file 252 may be directly attached to an email, an MMS and/or an SMS message. Thus, for these actions, the processor 242 may not be needed and the files may be directly provided to the application programs 225.

However, a text file may have to parsed for a URL before the URL could be saved as a browser bookmark or used to access a web page, so a processor 242, for example, a URL parser, shown in the data path may be used. In some embodiments of the present invention, the processor 242 may be an instant message importer if the file is being provided to a chat client, a contact parser if the file is being provided to a contacts database or a calendar parser if the file is being provided to the calendar. It will be understood that embodiments of the present invention are not limited to these examples.

Referring now to FIGS. 4A through 4D, exemplary operations of attaching, editing and processing the image and/or text files will be discussed. As illustrated in FIG. 4A, the image file and/or text file may be edited and forwarded as an MMS message and/or an email message. As shown therein, multiple pictures of a cat are included in the image file 410A. Then, the user edits the image file to select a particular image and adds text thereto as shown in the edited MMS message 415.

As shown in FIG. 4B, the text file 420B associated with the image file 410B can be edited as a note, emailed or saved to the calendar. As illustrated therein, the text of the text file is incorporated into a calendar entry 417. As discussed above, the information in the text file may be processed by, for example, a calendar parser, before it is entered into the calendar.

As shown in FIG. 4C, if a URL is present in the text file 420C associated with the image file 410C, it can be, for example, saved as a bookmark 427, used to access a web page from the mobile terminal or forwarded in a message. Again, as discussed above, the information in the text file 420C may be processed by, for example, a URL parser, before it the bookmark 427 is created.

Finally, as shown in FIG. 4D, if contact information is present in the text file 420D, it can be saved in a contacts database according to some embodiments of the present invention. For example, an image 410D may be taken of a business card including contact information, a text file 420D corresponding to the image 410D may be created, the information in the text file 420D may be processed by, for example, a contacts parser, and the parsed information may be stored in a contacts database 437.

It will be understood that in some embodiments of the present invention, the user may select text on the display using, for example, a text selection tool, and save the selected text as known content. For example, a user may select a URL in an image of a magazine article on the display. The user may then direct that the selected URL be stored as a URL (known content) in a text file. Thus, since the user tells the mobile terminal that the text is a URL, the text may be converted to the URL format, for example, http://www.xxxx.com, more accurately.

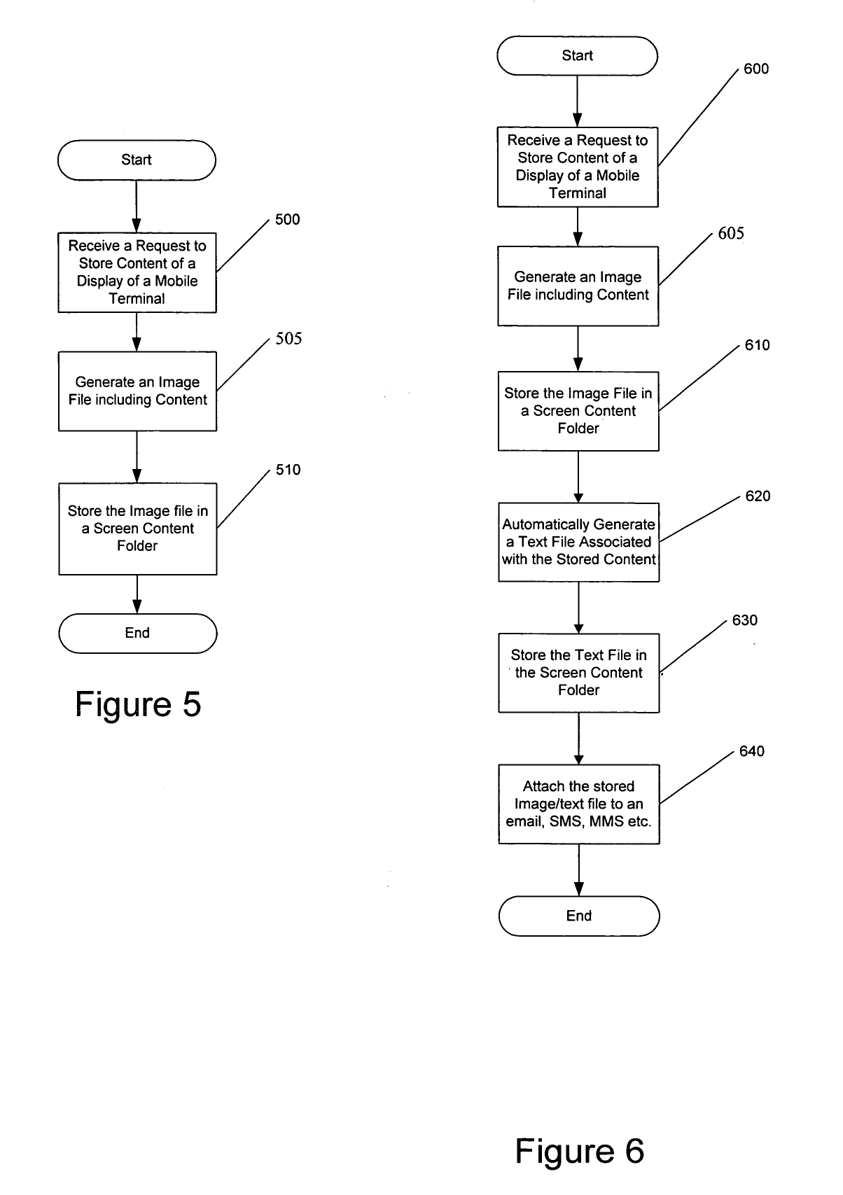

Operations of mobile terminals according to some embodiments of the present invention will now be discussed with respect to the flowcharts of FIGS. 5 through 7. Referring now to FIG. 5, operations begin at block 500 by receiving a request to store the content of a display associated with the mobile terminal. As discussed above, a user may press a button to indicate that they would like to store the current content of the display or select the content capture option from a menu in the mobile terminal. The button may be a dedicated button or an overloaded button without departing from the scope of the present invention. Furthermore, the content may include a picture taken with the mobile terminal, for example, a picture of a magazine page with interesting subject matter, a picture of a colleague's business card or anything of interest to the user, an MMS message, an SMS message, a web page, contact information and the like.

An image file including the content of the display may be generated responsive to the received request (block 505). The generated image file may be stored in a screen content folder regardless of a type of the content and/or a source of the content (block 510). Thus, as discussed above, the image file may be stored in a predictable location so the user can easily access and/or edit the image file.

Operations according to further embodiments of the present invention will now be discussed with respect to the flowchart of FIG. 6. Referring now to FIG. 6, operations begin at block 600 by receiving a request to store the content of a display associated with the mobile terminal. An image file including the content of the display may be generated responsive to the received request (block 605). The generated image file may be stored in a screen content folder regardless of a type of the content and/or a source of the content (block 610).

A text file associated with the generated image file may be automatically generated (block 620). The text file may include the text, if any, included in the image file. The generated text file may be stored in the screen content folder with the corresponding image file (block 630). As discussed above, in some embodiments of the present invention, as files are created, they may be given sequential numeric names as for ordinary photographs. For example, according to some embodiments of the present invention screen shots could be assigned file names like SSI001, SSI002, and so on for “ScreenShot Image” and SST001, SST002, and so on for “ScreenShot Text”. Corresponding graphic and text files may have the same serial number with different prefixes.

The stored image and/or text files may be provided to application programs, for example, attached to an email message, an MMS message, a SMS message (block 640). In some embodiments of the present invention, the text file may be forwarded to a text notes program. It will be understood that according to some embodiments of the present invention, the image and/or text file may be edited before the email, SMS and/or MMS messages are forwarded to their destination.

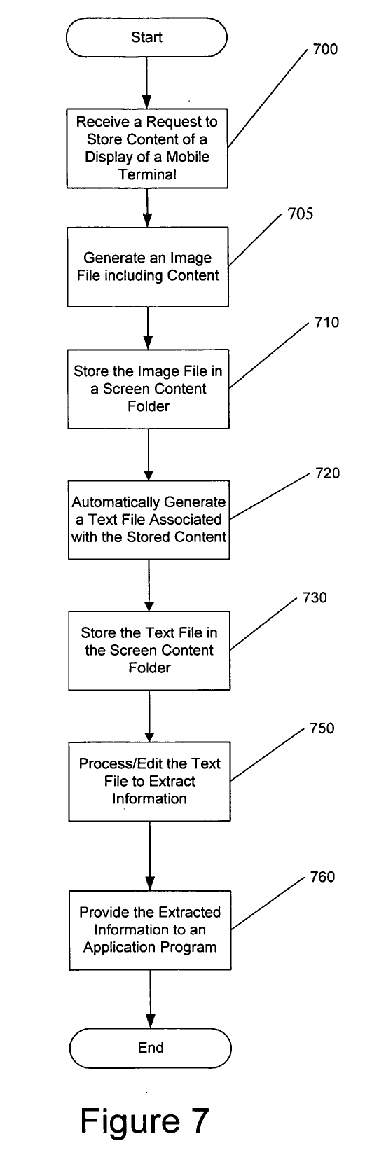

Operations according to still further embodiments of the present invention will now be discussed with respect to the flowchart of FIG. 7. Operations of blocks 700 through 730 are similar to those operations discussed above with respect to block 600 through 630 of FIG. 6 and, therefore, details with respect to blocks 700 through 730 will not be repeated herein. The text file may be processed or edited to extract information therefrom (block 750). As discussed above, different processors, for example, a URL parser, a contacts parser, a calendar parser and the like, may be used to extract information from the text file. The extracted information may be provided to application programs for use therein (block 760). The application programs may include, but are not limited to, for example, a contacts database, a calendar, a browser, a chat client and/or a bookmark storage unit.

As will be appreciated by one of skill in the art, the present invention may be embodied as a method, device, system, or computer program product. Accordingly, the present invention may take the form of an entirely hardware embodiment, a software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, CD-ROMs, optical storage devices, a transmission media such as those supporting the Internet or an intranet, or magnetic storage devices.

Computer program code for carrying out operations of the present invention may be written in an object oriented programming language such as Java®, Smalltalk or C++. However, the computer program code for carrying out operations of the present invention may also be written in conventional procedural programming languages, such as the “C” programming language and/or a lower level assembler language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Furthermore, the present invention was described in part above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The diagrams of FIGS. 2 through 4 illustrate the architecture, functionality, and operations of some embodiments of methods, systems, and computer program products for supplementing game resources using a portable electronic device. In this regard, each block may represent a module, segment, or portion of code, which comprises one or more executable instructions for implementing the specified logical function(s). It should also be noted that in other implementations, the function(s) noted in the blocks may occur out of the order noted in the figures. For example, two blocks shown in succession may, in fact, be executed substantially concurrently or the blocks may sometimes be executed in the reverse order, depending on the functionality involved.

In the drawings and specification, there have been disclosed exemplary embodiments of the invention. Although specific terms are employed, they are used in a generic and descriptive sense only and not for purposes of limitation, the scope of the invention being defined by the following claims.

That which is claimed is:

1. A method of saving content of a mobile terminal display, comprising:
receiving a request to store the content of a display associated with the mobile terminal;
generating an image file including the content of the display responsive to the received request; and
storing the generated image file in a screen content folder regardless of a type of the content and/or a source of the content.

2. The method of claim 1, further comprising:
automatically generating a text file associated with the generated image file, the text file including any text included in the image file; and
storing the generated text file in the screen content folder.

3. The method of claim 2, further comprising attaching the text file to an email message, a Multimedia Messaging Service (MMS) message, a Short Message Service (SMS) message and/or forwarding the text file to a text notes program.

4. The method of claim 1, further comprising attaching the image file to an email message and/or a Multimedia Messaging Service (MMS) message.

5. The method of claim 2, further comprising:
processing the image file and/or the text file to extract information therefrom; and
providing the extracted information to an application program for use therein.

6. The method of claim 5, wherein the application program comprises a contacts database, a calendar, a browser, a chat client and/or a bookmark storage unit.

7. The method of claim 2, further comprising editing the image file and/or the text file.

8. The method of claim 1, wherein receiving comprises:
receiving user input provided through a dedicated screen content button provided on the mobile terminal;
receiving user input provided through an overloaded button provided on the mobile terminal; or
receiving user input provided through a menu provided on the mobile terminal.

9. A mobile terminal comprising a content capturing module configured to receive a request to store content of a display associated with the mobile terminal, generate an image file including the content of the display responsive to the received request and store the image file a screen content folder regardless of a type of the content and/or a source of the content.

10. The mobile terminal of claim 9, further comprising a text conversion circuit that is configured to automatically generate a text file associated with the stored image file that includes any text in the image file content and store the generated text file in the screen content folder.

11. The mobile terminal of claim 10, wherein the text conversion module is further configured to attach the text file to an email message, a Multimedia Messaging Service (MMS) message, a Short Message Service (SMS) message and/or forwarding the text file to a text notes program.

12. The mobile terminal of claim 9, wherein the content capturing module is further configured to attach the image file to an email message and/or a Multimedia Messaging Service (MMS) message.

13. The mobile terminal of claim 10, wherein the content capturing module is further configured to:
process the image file and/or the text file to extract information therefrom; and
provide the extracted information to an application program for use therein.

14. The mobile terminal of claim 10, wherein the content capturing module is further configured to edit the image file and/or the text file.

15. The mobile terminal of claim 9, wherein the content capturing module is further configured to:
receive user input provided through a dedicated screen content button provided on the mobile terminal;
receive user input provided through an overloaded button provided on the mobile terminal; or
receive user input provided through a menu provided on the mobile terminal.

16. A computer program product for saving content of a mobile terminal display, the computer program product comprising:
a computer readable medium having computer readable program code embodied therein, the computer readable program medium comprising:
computer readable program code configured to receive a request to store the content of a display associated with the mobile terminal; and
computer readable program code configured to generate an image file including the content of the display responsive to the received request; and
computer readable program code configured to store image file in a screen content folder regardless of a type of content and/or a source of the content.

17. The computer program product of claim 16, further comprising:
computer readable program code configured to automatically generate a text file associated with the image file, the text file including any text included in the image file; and
computer readable program code configured to store the generated text file in the screen content folder.

18. The computer program product of claim 17, further comprising computer readable program code configured to attach the text file to an email message, a Multimedia Messaging Service (MMS) message, a Short Message Service (SMS) message and/or forwarding the text file to a text notes program.

19. The computer program product of claim 16, further comprising computer readable program code configured to attach the image file to an email message and/or a Multimedia Messaging Service (MMS) message.

20. The computer program product of claim 17, further comprising:
computer readable program code configured to process the image file and/or the text file to extract information therefrom; and
computer readable program code configured to provide the extracted information to an application program for use therein.

21. The computer program product of claim 20, wherein the application program comprises a contacts database, a calendar, a browser, a chat client and/or a bookmark storage unit.

22. The computer program product of claim 17, further comprising computer readable program code configured to edit the image file and/or the text file.

23. The computer program product of claim 16, wherein the computer readable program code configured to receive a request comprises:
computer readable program code configured to receive user input provided through a dedicated screen content button provided on the mobile terminal;
computer readable program code configured to receive user input provided through an overloaded button provided on the mobile terminal; or
computer readable program code configured to receive user input provided through a menu provided on the mobile terminal.
